(19) United States
(12) Patent Application Publication
(10) Pub. No.: US 2017/0089835 A1
(43) Pub. Date: Mar. 30, 2017

(54) Sensor Element For Photoluminescence Measurements, Photoluminescence Detection Means, Method For Operating Photoluminescence Detection Means, Method For Producing A Sensor Element And Use Of A Sensor Element

(71) Applicant: Universität Stuttgart, Stuttgart (DE)

(72) Inventors: Martin Bogner, Bruckmuhl-Waldheim (DE); Karsten Frenner, Leonberg (DE); Joachim Sägebarth, Heimsheim (DE)

(21) Appl. No.: 15/273,022

(22) Filed: Sep. 22, 2016

(30) Foreign Application Priority Data
Sep. 24, 2015 (DE) 10 2015 218 422.6

(51) Int. Cl. G01N 21/64

(52) U.S. Cl. CPC G01N 21/645; G01N 21/6428; G01N 2021/6439; G01N 2201/061; G01N 2201/068

(57) ABSTRACT

The application pertains to a sensor element (11) for photoluminescence measurements, with an optically transparent carrier structure (19), on which is placed a luminescence structure (21) configured for intensifying and transmitting luminescence light to the carrier structure (19), wherein the luminescence structure has a nanostructured surface (25) oriented away from the carrier structure (19).

### FIELD OF THE INVENTION

The invention relates to a sensor element for photoluminescence measurements, photoluminescence detection means, a method for operating photoluminescence detection means, a method for producing a sensor element and a use of a sensor element for photoluminescence measurements.

### BACKGROUND OF THE INVENTION

Photoluminescence biosensors have so far been set up only for detection with a single, specific sensor element. If other sensors are to be used, it is necessary to adapt an optical filter array for filtering luminescence light and excitation light, in some cases additionally also a light source for luminescence excitation. Corresponding installations for photoluminescence measurements are thus inflexible and difficult to adjust to different substances to be detected and/or different measuring methods. Furthermore, the problem remains that substances that intrinsically emit light only weakly, for example in the case of intrinsic fluorophores, often produce only insufficient fluorescence signal intensities. In such cases, it is necessary to have recourse to fluorescence markers, which causes modifications of the substances to be analyzed, or it is necessary to rely on an increase of the intensity of the excitation light. In this respect, it is however possible for the fluorophores to become damaged and their bleaching to be accelerated. Furthermore, the background light is then very intensive, which ultimately reduces the signal intensity and/or results in a poor signal/noise ratio. Conventional methods furthermore only allow comparatively large substance quantities to be analyzed. Since the methods are inflexible and very specific, it is hardly possible to detect several substances simultaneously. A selection of specifically adapted external filter systems and/or specially adapted lighting is complex and costly.

### BRIEF SUMMARY OF THE INVENTION

The aim of the invention is to provide a sensor element for photoluminescence measurements, photoluminescence detection means, a method for operating photoluminescence detection means, a method for producing a sensor element and a use of a sensor element for photoluminescence measurements in which the mentioned disadvantages do not occur.

The aim is achieved by providing the objects of the independent claims. Advantageous embodiments arise from the dependent claims.

In particular, the aim is achieved by providing a sensor element for photoluminescence measurements that has an optically transparent carrier structure on which a luminescence structure is arranged that is designed for intensifying and transmitting luminescence light to the carrier structure, wherein the luminescence structure has a nanostructured surface averted from the carrier structure. The nanostructured surface makes it in particular possible to increase—preferably via plasmonic resonances—a radiation intensity emitted from luminescence centers, in particular fluorophores, placed on the surface, wherein evanescent waves in particular can be coupled into the luminescence structure via the nanostructured surface. The luminescence light intensified at the nanostructured surface is transmitted—in particular in the form of evanescent waves—from the luminescence structure to the carrier structure and there preferably decoupled. It is thus possible to achieve a very high gain in luminescence intensity up to a range of 10⁷ at the nanostructured surface, so that weak fluorophores can also be detected without excessive increase or even without any increase of the intensity of the excitation light irradiated by a radiation source and thus without endangering the fluorophores. Furthermore, very small substance quantities, for example in a very small volume of up to 10⁻¹² m³ can be analyzed. The sensor element furthermore has a very simple design, can be produced cost-effectively and is easy to replace. It can thus be replaced in a simple manner depending on the measurements to be concretely performed and/or on the substances to be detected. In particular, the sensor element can be designed as a disposable sensor, i.e. as one-time sensor for a single use. It is thus possible in a very fast and flexible manner to configure a device using the sensor element by choosing a suitable sensor element for a concrete analytical task. The sensor element can have a low analysis volume.

A carrier structure is understood to be in particular a structure that is configured for providing a carrier support for the luminescence structure, so that the luminescence structure can be arranged on the carrier structure.

Luminescence structure is understood to mean in particular a structure that on the one hand is suited for intensifying luminescence generated in the area of a surface of the luminescence structure and, on the other hand, for transmitting luminescence light—preferably in the form of evanescent waves—on a surface opposite the surface on which the luminescence arises.

“Intensification” of luminescence light or luminescence radiation is understood here to be in particular an increase of the intensity of the luminescence radiation or of the luminescence light independently of the concrete mechanism of the intensity increase. It is possible that thanks to the nanostructure of the nanostructured surface at least a specific excitation wavelength is specifically amplified, whereby in particular standing waves that are excessively high in their intensity can be generated. The thus increased excitation intensity results at the same time in an increase of the luminescence signal. Alternatively, or additionally, it is possible that the luminescence radiation itself is amplified, for example through the amplification of the evanescent components of the luminescence radiation. An increase of the radiation intensity through plasmonic coupling or plasmonic resonance, like in an ideal Pendry lens, is particularly preferred, and is achieved in a particularly preferred manner through metal-enhanced fluorescence (MEF) effect.

The luminescence structure, which is formed preferably as at least one thin metallic layer, preferably as at least two thin metallic layers, has on the one hand an intensifying effect on the luminescence radiation and simultaneously an attenuating effect for wideband excitation light and scattered light. In this respect, the luminescence structure is formed in a particularly preferred embodiment as a Pendry lens. In a preferred exemplary embodiment, the luminescence structure is at least partly executed as material with a negative index of refraction or has a meta-material. A meta-material in this connection is in particular an artificially produced structure whose permeability for electric and magnetic fields deviates from what is customarily found in nature. This is achieved through specially produced, mostly periodical, microscopically fine structures, in particular cells or individual components of electric or magnetically effective materials on the inside thereof.

One material that has an index of refraction of −1 (Wesselago medium) allows the production of a planar lens that is not bound to the resolution limitation of classical optics. Such a lens, also called Pendry lens, is in the simplest case a planar layer of such a material. Proper use of a Pendry lens is in particular the imaging of structures with structure sizes below the wavelength. A necessary condition for achieving such imaging is an amplification of evanescent waves of an observed object. In the frame of the invention, the Pendry lens is used preferably not for imaging but for amplifying evanescent waves. However, such a Wesselago medium does not exist in nature. In many metals—in particular Ag, Au, Cu—it is however possible for collective surface charge transfers (plasmons) to be excited by evanescent waves at optical frequencies. Pendry has shown that when plasmons are present, it is not the index of refraction but at least the dielectricity figure that can become —1, which is sufficient at least for a simple imaging and/or amplification (Pendry, J. B. (Oct 2000), Negative Refraction Makes a Perfect Lens, Phys. Rev. Lett., 85, 3966-3969). The amplification mechanism can be explained as a resonant coupling of plasmons on both surfaces of the material. The problem with such metallic layers is that they absorb, which is why they have to be designed as thin as possible for a lens. The attenuation involved with the absorption is however desired, according to the invention, for the excitation light, wherein a compromise is sought between the layer thickness on the one hand and the amplification on the other hand. With silver as the material for the luminescence structure, the layer thickness is selected to be preferably between 30 nm to 50 nm, which corresponds to an amplification by a factor of 100 for the useful light and an attenuation by a factor of 10000 to 20000 for the scattered light.

In the frame of the invention, a combination of a coupling of fluorescence with surface plasmons, Pendry lenses, rigorous theory of diffraction and geometric optics is used, wherein it is possible thanks to this combination to achieve a selective amplification of a specific excitation wavelength and of the generated luminescence light with simultaneous attenuation of the scattered light and of the unamplified wideband excitation light.

The term “luminescence” is understood here generally as the phenomenon of a radiance transition of a substance from a first state of higher energy to a second state of lower energy under emission of at least one photon. The substance can be in particular a molecule, an atom, a complex, an ion or another suitable physical entity. The term “luminescence” includes in particular the phenomena of fluorescence, phosphorescence, chemiluminescence and bioluminescence. In the context of the invention, luminescence is to be understood most preferably as meaning fluorescence.

Nanostructured surface is understood to be a surface that has a structure whose relevant dimensions, in particular the size of individual structure elements of the structure, have a characteristic length on the nanometer scale, in particular in the range of some 10 nm to some 100 nm, most preferably in the range on the order of the wavelength of an electromagnetic radiation to be observed, in particular of visible light. The nanostructured surface can exhibit, as nanostructures or structure elements, for example raised or depressed elements, in particular cavities, or other suitable structure elements. The structure of the nanostructured surface is preferably designed to be periodic or near-periodic, if applicable with minor deviations from strict periodicity in particular in order to suppress undesirable resonance effects. An aperiodic structure is however also possible.

The nanostructured surface is preferably made of metal, it is particularly preferred if it has at least one metal or at least one metal alloy. Generally, a material is used for the nanostructured surface, preferably for the luminescence structure, that can have plasmonic resonances. In particular silver, gold, copper or aluminum are suitable as materials for the nanostructured surface and/or for the luminescence structure.

The nanostructured surface in terms of its characteristic dimensions of the structure elements is preferably also adapted to certain wavelength ranges to be amplified of the excitation radiation and/or of the luminescence radiation. In particular, the nanostructure surface is thus preferably adapted in respect of its nanostructure depending on wavelength. It is then possible for the sensor element to be designed specifically for amplifying a particular wavelength range.

It is also possible for the nanostructure on the nanostructured surface to vary along the nanostructured surface, so that it is adapted in various surface areas of the nanostructured surface to various wavelength ranges. In particular, it is possible in such a case to use the sensor element to analyze different substances in different ranges and/or to perform different photoluminescence measurements.

Different sensor elements in which the nanostructured surface is adapted respectively to different wavelength ranges can be exchanged in a simple and cost-effective manner so that different photoluminescence measurements can be performed by means of the sensor elements in a highly flexible and quick manner.

Preference is given to an embodiment of the sensor element that is characterized in that it has a layer structure. Layer structure generally is understood to mean an arrangement of at least two layers on top of or next to one another. In this respect, the carrier structure preferably constitutes at least a first sensor layer, wherein the luminescence structure forms at least a second sensor layer. Alternatively, or additionally, the carrier structure is formed as at least a first sensor layer, with the luminescence structure being designed as at least a second sensor layer. The carrier structure in this case is also called carrier layer, the luminescence structure also luminescence layer. The layer structure can preferably be produced lithographically and/or through an embossing process, in particular is produced lithographically and/or through an embossing process. In this manner, the sensor element is built and can be produced in a very cost-effective and simple manner. It is thus in particular possible without further ado to exchange the sensor element for another sensor element in order to analyze different substances and/or perform different photoluminescence measurements.

The sensor element preferably has an analyzer system for materials analytics and a filter system for optical filtering of luminescence light integrally with one another. In this case, the luminescence structure preferably serves in particular both for materials analytics as well as optical filtering. For materials analytics, an analyzer system, preferably the luminescence structure, preferably comprises reactants that react with a substance to be analyzed or that bind the substance to be analyzed in another manner, for example via a sorption mechanism, in particular physisorption through van-der-Waals forces, or any other suitable manner. It is possible for the analyzer system to be designed in such a way that luminescence occurs only when a substance to be analyzed has reacted with a reactant or is bound to the reactant. It is however also possible for unbound substances to be rinsed off by the luminescence layer, so that only bound substances are then detected by means of a photoluminescence measurement. The filtering system is preferably provided by the luminescence structure in that the nanostructured surface is designed for amplifying certain excitation and/or luminescence wavelengths. In this respect it is possible to achieve a very high luminescence amplification on the one hand and preferably a very clear-cut separation of excitation light and luminescence light on the other hand. This in turn makes possible the simple and cost-effective use of a wideband radiation source for the photoluminescence measurement. Since the analyzer system and the filtering system are provided together integrally in the sensor element, such elements that in known means for photoluminescence measurements are typically very expensive can here be produced in a cost-effective manner and placed with the replaceable sensor element. A means for photoluminescence measurements that uses the sensor element thus no longer requires a complex and expensive optical filtering system and can be designed overall less expensively. Furthermore, according to the embodiment proposed here, the cost-effective analyzer and filtering systems are allocated to the replaceable sensor element whilst more expensive elements of a photoluminescence detection installation, such as for example a radiation source and a detector device for detecting electromagnetic radiation can be provided to be united with the detection means. The sensor element can then be exchanged according to need, so that the detection means can be operated very flexibly and cost-effectively.

Preference is also given to an embodiment of the sensor element that is characterized in that reactive luminescence centers are arranged in the area of the nanostructured surface of the luminescence structure. In this manner, the luminescence structure is designed in particular as analyzer system. The reactive luminescence centers allow in particular materials analytics in a simple and cost-effective manner.

Reactive luminescence center is understood to mean in particular a substance—in particular a molecule or a complex—that is intended to react with a substance to be tested or to bind the substance that is to be tested and, in combination with the substance to be tested—in particular after the substance to be tested has reacted and/or become bound to the luminescence center—to emit luminescence radiation and/or to modify emitted luminescence radiation. The reactive luminescence centers are preferably analytes, preferably fluorophores.

According to one embodiment of the sensor element, the reactive luminescence centers are at least partly immobilized on the nanostructured surface, preferably by means of covalent bonds. Alternatively, or additionally, it is possible for the luminescence centers to be dispersed at least partly in a matrix material arranged on the nanostructured surface. The term “dispersed” is understood here to mean a distribution, in particular a stochastic distribution, of the luminescence centers in the matrix material. A matrix material is understood to be a material which on the one hand is suitable for holding the reactive luminescence centers in dispersed, in particular stochastically distributed form, and on the other hand is aimed at enabling a diffusion of a substance to be analyzed into the matrix material and to the reactive luminescence centers. In this respect, it is preferably provided for the matrix material to be adapted specifically for a diffusion of substances to be detected. In particular, the appropriate selection of diffusion coefficients, in particular the appropriate selection of the composition and/or configuration of the matrix material, in particular special pore sizes or the use of polar matrix molecules, make it possible to adjust the ion selectivity of the matrix material.

One embodiment of the sensor element is also preferred which is characterized in that the nanostructure surface has nanocavities. The nanocavities are preferably arranged periodically or near-periodically, if applicable with minor deviations from strict periodicity in particular in order to suppress undesirable resonance effects. An aperiodic arrangement is however also possible. The term “nanocavity” is understood to be in particular a depression in the nanostructured surface having a characteristic dimension, in particular a characteristic depth—measured from a surface, in particular from a middle surface or from an outmost surface—and/or a width, in particular a diameter, on the nanoscale. Such nanocavities can have various geometric shapes, they can in particular be formed with a cross-section that is quadratic or rectangular, round, in particular circular or oval, or otherwise bounded recesses in the nanostructured surface.

Nanocavities are in particular suitable for the specific wavelength-selective amplification of electromagnetic radiation, wherein a characteristic combination of length, in particular depth, periodicity and width of the nanocavities can be adjusted to a wavelength to be amplified. Such nanocavities are furthermore suitable in a particular manner for holding a substance to be analyzed, in particular to capture or fix it.

It is preferably provided for the reactive luminescence centers to be placed at least partly in the nanocavities. In this respect, it is possible for the luminescence centers to be immobilized partly on walls or on the bottom of the nanocavities, in particular through covalent bonds, and/or for a matrix material to be placed in the matrix material, wherein the reactive luminescence centers are at least partly dispersed in the matrix material placed in the nanocavities.

The prevailing conditions in the nanocavities in particular are favorable for the formation of standing waves of electromagnetic radiation, which results in a high intensification of the luminescence, in particular when the luminescence radiation arises in the nanocavities, for example because reactive luminescence centers are provided here.

One embodiment of the sensor element is also preferred which is characterized in that on the luminescence structure a fluid conducting structure is arranged that is configured for conducting a fluid over the nanostructured surface. A fluid conducting structure is understood here to mean in particular a structure that is configured for conducting a fluid, in particular a solution, having a substance to be analyzed over the nanostructured surface and, in doing so, to hold it in particular in the area of the nanostructured surface. The fluid conducting structure is preferably executed as a conducting layer, wherein, in a particularly preferred embodiment, it is integrally formed with the carrier structure and the luminescence structure, in particular as third layer over the luminescence structure. It is possible for the fluid conducting structure to be formed lithographically, in particular as further layer of the layer structure of the sensor element. Preferably, the conducting structure is made of synthetic material, wherein it has plastic or consists of plastic.

The sensor element preferably has connectors, in particular an inlet for a fluid to the fluid conducting structure and/or a discharge for the fluid away from the fluid conducting structure. These connectors too can preferably be produced lithographically.

The fluid conducting structure is preferably designed to be optically transparent so that in particular electromagnetic radiation emanating from a radiation source can reach the luminescence structure via the conducting structure.

By means of the fluid conducting structure, it is possible to direct a substance to be analyzed, in particular a solution of a substance to be analyzed, via the luminescence structure and in particular via the nanostructured surface and thus to bring the substance to be analyzed in contact with the nanostructured surface and in particular with the reactive luminescence centers.

The sensor element preferably has—in particular in this sequence above or next to one another—the carrier structure, the luminescence structure and the fluid conducting structure, with it being in particular achievable as layer structure, wherein the layers are formed integrally with one another and preferably lithographically and/or through an embossing process. In this manner, the sensor element can be built and produced in a very cost-effective and simple manner as replaceable or single-use part.

Preference is given to an embodiment of the sensor element that is characterized in that the luminescence structure comprises a first luminescence layer that has the nanostructured surface. The luminescence structure preferably has a second luminescence layer that is arranged on the carrier structure. The result is thus preferably the following layer structure: first the carrier structure of the carrier layer, on top of that the second luminescence layer and on that again the first luminescence layer which has the nanostructured surface. The first luminescence layer preferably has a material that is different from a material of the second luminescence layer. It is however also possible for the second luminescence layer and the first luminescence layer to have the same or identical material or to be constituted of the same or identical material. In particular if the first luminescence layer and the second luminescence layer have different materials, an intermediate layer of a third material is preferably provided between the first luminescence layer and the second luminescence layer, in particular as so-called material interface. This makes it possible to prevent undesired reactions of the different materials of the two luminescence centers with one another. A subdivision of the luminescence structure into a first luminescence layer with the nanostructured surface and a second luminescence layer enables in particular a separation of the functions of the materials analytics and of the luminescence generation on the one hand as well as the transmission and filtering of the luminescence light to the carrier structure on the other hand. Whilst the first luminescence layer is in particular for materials analytics and the intensification as well as coupling of the luminescence radiation generated on the nanostructured surface, the second luminescence layer is adapted for an efficient transmission, amplification and filtering of the luminescence radiation, in particular in the form of evanescent waves. Furthermore, the second luminescence layer is preferably configured for transmitting the luminescence radiation to the carrier structure, wherein, in particular during the transition from the second luminescence layer into the carrier structure, a decoupling of the evanescent waves as waves propagating freely in the carrier structure occurs. In doing so, depending on the frequency of the luminescence radiation, a characteristic angle of spread of the propagating waves will be formed. The second luminescence layer is preferably executed as Pendry lens.

A layer thickness of the first luminescence layer preferably is from at least 100 nm up to at most 500 nm, wherein the thickness depends in particular on a depth of nanocavities of the nanostructured surface. A layer thickness of the second luminescence layer is preferably from at least 30 nm up to at most 50 nm.

Alternatively, it is preferably provided for the luminescence structure to be executed as continuous, preferably homogenous luminescence layer that has the nanostructured surface. In this context, the term “continuous” means in particular that within the luminescence layer, there is no phase boundary and/or no material boundary. The term “homogenous” means here in particular that in any case there are for the effects relevant here no significant fluctuations in the composition, density or other relevant physical properties within the luminescence structure, with the exception of the nanostructuring of the nanostructured surface. A continuous, in particular homogeneous luminescence layer can be produced in a particularly simple and cost-effective way. The luminescence structure in this case is preferably executed generally as a Pendry lens.

A layer thickness of the luminescence structure executed as a continuous luminescence layer is preferably from at least 100 nm up to at most 600 nm, preferably up to at most 550 nm, preferably up to at most 500 nm.

Preference is also given to an embodiment of the sensor element that is characterized in that the carrier structure is executed as carrier substrate. In this case, carrier substrate here is understood to be in particular an optically transparent construct, in particular an optically transparent layer, which preferably apart from the transparency and the ability of allowing electromagnetic radiation to pass through, has no optical functions. In particular, the carrier substrate has no properties beyond the natural material properties, and specifically no properties generated as optical refraction or diffraction element, in particular no diffractive properties. In this case, the sensor element is designed particularly simply and cost-effectively. Optical means for the detection of the luminescence light in this case are not part of the sensor element but to be associated rather with a photoluminescence detection means with which the sensor element is used. The carrier substrate can be executed as simple glass substrate, in particular as quartz substrate.

Alternatively, or additionally, it is provided that the carrier structure is formed as diffractive optical carrier element. In this context, carrier element here is understood in particular to be a construct, in particular a layer, that on the one hand is optically transparent, on the other hand is able to carry the structures placed on it, in particular the luminescence structure and/or the fluid conducting structure, wherein the optical carrier element is executed simultaneously as optical element, in particular for the purpose of focusing or collimating luminescence radiation. The optical carrier element preferably has a plastic with a high diffractive index or is made of a plastic with a high diffractive index, for example polycarbonate. The luminescence light intensified and filtered in the luminescence structure is then decoupled with the aid of the highly refractive optical carrier element and converted into propagating light modes. It is possible that the optical carrier element has an embossed, in particular a hot embossed or lithographically produced structure. It is particularly preferred for micro-lenses to be provided on the optical carrier element, in particular by means of hot embossing.

The optical carrier element is preferably configured such that luminescence radiation from different reactive luminescence centers and/or from different substances to be analyzed, wherein the latter emit different frequencies or wavelengths, is deflected in different directions. It is then possible to detect the different substances to be analyzed by means of different detector units or in different areas of a spatially resolved detector, for example a CC or CMOS sensor. In this way, it is possible with one and the same sensor element to simultaneously examine a plurality of different substances to be analyzed. In order to achieve this, the material that comprises the optical carrier element or which constitutes the optical carrier element and/or its structure is chosen accordingly.

A layer thickness of the carrier substrate is preferably 1mm, in particular in the case of glass as a material for the carrier substrate.

A layer thickness of a diffractive layer for the carrier structure is preferably from at least 5 mm to at most 10 mm. If the diffractive layer is placed on a carrier layer, the latter preferably has a greater thickness.

Finally, preference is given to one embodiment of the sensor element that is characterized in that the luminescence structure has at least two different areas, wherein the areas differ in relation to the nanostructured surface and/or with respect to the reactive luminescence centers. It is thus possible for the luminescence structure to have a first area with a first nanostructured surface and a second area with a second nanostructured surface, wherein the nanostructure of the second nanostructured surface is different from the nanostructure of the first nanostructured surface. Alternatively, or additionally, it is possible for the luminescence structure to have a first area with first reactive luminescence centers and a second area with second reactive luminescence centers, wherein the first reactive luminescence centers differ from the second reactive luminescence centers. In this way, it is possible to detect different substances to be analyzed in different areas of the luminescence structure and/or to perform different photoluminescence measurements. The sensor element can thus be used in a particularly flexible manner.

The aim is also achieved by providing a photoluminescence detection means having a radiation source, configured for emitting electromagnetic radiation. The photoluminescence detection means furthermore has a holding means configured for detachably holding a sensor element in a beam path of the radiation source, as well as a detector device configured for the detection of electromagnetic radiation. The holding means in this case is configured for holding a sensor element according to one of the previously described exemplary embodiments in the beam path of the radiation source between the radiation source and the detector device. Since the sensor element is held detachably by the holding means, it is possibly more simply, more cost-effectively and more quickly to replace one sensor element in the photoluminescence detection means with another sensor element and thus to perform very flexibly, cost-effectively and also in quick temporal succession different photoluminescence measurements, namely in particular with respect to different substances to be analyzed and/or with respect to different measuring techniques. The only requirement in this respect is to place in the holding means a sensor element adapted for the specific substances to be analyzed or for a specific measuring method to be used. The advantages that have already been explained in relation to the sensor element are thus essentially achieved in conjunction with the photoluminescence detection means. It also becomes evident that the facilities provided specifically for the measurement to be performed such as an analysis system and a filtering system for filtering luminescence radiation can be implemented in the sensor element, whilst the detection means can be configured non-specifically for a plurality of different luminescence measurements. It is then configured for a specific measurement in that a sensor element adapted to the specific measurement is placed in the holding means.

Radiation source is understood to be in particular a device that is configured for emitting an electromagnetic radiation, in particular in a given direction or a given solid angle, wherein in particular a predetermined beam path is given by the radiation source for the electromagnetic radiation. Since the sensor element can have a highly efficient specific filtering system for luminescence radiation, it is not necessary to configure the radiation source specifically for the emission of a particular wavelength or of a particular wavelength range. Rather, it can advantageously be a wideband radiation source. The radiation source is preferably configured for emitting visible light, i.e. electromagnetic radiation in the visible wavelength range. In a particularly preferred embodiment, the radiation source is executed as wideband light source, in particular as a source of white light.

A holding means is understood to be in particular a device that is capable of holding a sensor element in a spatially predetermined position, in particular in a detachable or removable manner. It is possible for the holding means to be configured for fastening the sensor element, wherein it preferably has a fastening position and a release position into which it can be switched according to need. It is however also possible for the holding means to provide merely a support for the sensor element, onto which the latter can be placed. In this case, it is possible for the holding means to have at least one stopper for the sensor element, preferably at least two stoppers oriented in an inclined fashion or orthogonally to one another in order to position the sensor element unequivocally within a supporting plane.

The fact that the holding means is configured for holding the sensor element in the beam path of the radiation source between the radiation source and the detector device means in particular that the luminescence radiation of the sensor element is observed on its side opposite the radiation source—as seen in the direction of the beam path. The sensor element in this respect preferably divides the space into two half-spaces, wherein a first half-space is preferably above the sensor element and a second half-space is preferably below the sensor element. The radiation source is for example placed in the first half-space whereas the detector device is placed for example in the second half-space, or vice-versa. This arrangement enables the excitation light to be attenuated by the sensor element in a particularly efficient manner, with only the luminescence light being coupled efficiently as evanescent waves in the luminescence structure and transmitted by the latter to the carrier structure, amplified and from there again released as propagating waves towards the detector device. This ensures a particularly good ratio of signal to noise, wherein the attenuation of the excitation light from the radiation source is determined in particular through a thickness of the luminescence structure, in particular of the luminescence layer, and can reach up to a factor of 10⁻⁵. At the same time, the luminescence signal is intensified very efficiently through the luminescence structure and in particular through the nanostructured surface, so that it is readily possible, using the construction described here, to observe also weak fluorophores, in particular with an excitation intensity emitted by the radiation source in which it is possible to prevent the observed fluorophores from becoming damaged, destroyed or prematurely bleached.

A detector device is understood to mean in particular a device that is capable of detecting electromagnetic radiation, wherein the detector device is preferably configured for detecting luminescence radiation, especially in the visible spectrum.

Preference is given to an embodiment of the photoluminescence detection means that is characterized in that it comprises a sensor element according to one of the previously described exemplary embodiments. The advantages previously described are thus achieved in a particular manner.

Preference is given to an embodiment of the photoluminescence detection means that is characterized in that the detector device has a camera. This represents a design of the photoluminescence detection means that is both easy and efficient. The camera preferably has integrated optical means. In particular, the camera preferably has a projection plane sensitive to electric radiation and optical means configured for representing on the projection plane the electromagnetic radiation incident in the camera. It is preferably provided for an immersion medium to be placed between an input element, i.e. a first part of the optical means, in particular a cover glass or an entrance lens of the camera, and one of the front face of the carrier structure oriented towards the camera; the immersion medium is for example water or an immersion oil, in particular an immersion medium known in the field of microscopy. The immersion medium is preferably chosen such that the luminescence radiation, while in transition into the immersion medium, is not subjected to the effect of total reflection. Luminescence radiation with different wavelengths is deflected in different directions. This can then be represented in various areas of the projection plane.

Alternatively, or additionally, the detector device preferably has a plurality of detector units arranged in an offset manner to one another. Such detector units can be executed for example as separate cameras or as separate optical sensors. It is also possible for the plurality of staggered detector units to be executed in such a way that an optical sensor is provided that has separate light-sensitive zones placed in an offset manner to one another and that can be evaluated separately.

Preferably, the photoluminescence detection means have an imaging optical means outside of the detector unit and arranged separately and independently from the latter for representing luminescence radiation on projection planes of the staggered detector units. In this case, the detector units themselves most preferably have no optical elements. It is possible that an immersion medium is placed between a first optical element for projecting on the detector units and a front face of the carrier structure oriented towards this optical element. This is most preferably chosen such that the luminescence radiation, while in transition into the immersion medium, is not subjected to the effect of total reflection and thus luminescence radiation of different wavelengths is deflected in different directions and in particular onto different detector units placed in offset manner to one another. This makes it possible to analyze different substances to be analyzed and/or to perform luminescence measurement using the different detector units simultaneously.

Alternatively, or additionally, the detector device preferably has a planar detector, preferably a planar detector that has light-sensitive detector elements that are placed in a matrix-like manner and can be individually analyzed. The planar detector is executed in a particularly preferred embodiment as CCD sensor or as CMOS sensor. The design of the detector device as planar detector means a design of the detector device that is as simple as it is cost-effective and both very efficient and flexible.

In this case, the carrier structure is most preferably executed as a diffractive optical carrier structure, wherein then the imaging optical means for representing on the projection plane of the planar detector is integrated in the sensor element. The planar detector itself preferably has no optical means. The photoluminescence detection means preferably also has—with the exception of the optical means integrated in the sensor element—no detection optical means serving for the detection of luminescence light.

In a particularly preferred embodiment, the planar detector is executed as a holding means, so that the sensor element can be placed directly onto the planar detector. In doing so, the carrier structure in particular, as diffractive optical carrier element and thus as imaging optical means, lies directly on the planar detector, so that the luminescence light can be decoupled with a high efficiency and without losses at the carrier layer in propagating waves and transmitted to the planar detector. In this connection, the diffractive optical carrier element is preferably executed such that luminescence light of different wavelengths is deflected in different directions. By means in particular of the matrix-like planar detector with separately analyzable local zones, it is then possible for different areas of the planar detector to be used for different analytical tasks and/or luminescence measurements.

Lastly, the aim is also achieved by providing a method for operating a photoluminescence detection means having the following steps: a first sensor element is placed between a radiation source and a detector device. A first photoluminescence measurement is performed. The first sensor element is removed and a second sensor element is placed—in particular instead of the first sensor element—between the radiation source and the detector device, and a second photoluminescence measurement is performed. In the frame of the method, the switch between different photoluminescence measurements and/or different substances to be analyzed and/or other different parameters is very flexible, by exchanging the sensor element. The sensor element in this respect is preferably a single-use or disposable element that is discarded after a measurement and replaced with a new sensor element.

In the frame of the method, a first sensor element according to one previously described exemplary embodiment is preferably used. The second sensor element is also preferably executed according to one of the previously described exemplary embodiments. In the frame of the method, a photoluminescence detection means is still preferably operated according to one of the previously described exemplary embodiments.

Preference is given to one embodiment of the method that is characterized in that the second sensor element is executed differently from the first sensor element and/or in that the second photoluminescence measurement is different from the first photoluminescence measurement. In this respect, the sensor elements can be different in particular in relation to the nanostructure of the nanostructured surface and/or with respect to the reactive luminescence centers that are placed on the nanostructured surface. The photoluminescence measurements differ preferably with respect to different substances to be analyzed and/or with respect to the type of measurement or the used measuring method, wherein they can differ in particular in terms of the analyzed wavelengths.

Embodiments of the method are particularly preferred in which both the first sensor element is chosen to be different from the second sensor element as well as the first photoluminescence measurement is chosen to be different from the second photoluminescence measurement.

The aim is also achieved by providing a method for producing a sensor element, having the following steps: a carrier structure is provided, a luminescence layer is placed on the carrier structure, wherein the carrier structure is produced with a nanostructured surface. By means of the method, it is very easy and cost-effective to produce a sensor element. Particular preference is given in the frame of the method to a sensor element according to one of the previously described exemplary embodiments.

Preference is given to one embodiment of the method in which the luminescence structure is placed on the carrier structure by means of a lithographic method and/or through an embossing process. In particular, the sensor element is preferably built in layers. In particular, the nanostructured surface is preferably produced lithographically and/or through an embossing process.

It is preferably provided for a fluid conducting structure to be placed on the luminescence structure. The fluid conducting structure too is preferably produced lithographically and/or in particular placed in layers on the luminescence structure.

In the frame of the method, preferably at least one first sensor layer is formed as carrier structure and at least one second sensor layer for the luminescence structure. In the frame of the method, reactive luminescence centers are preferably arranged in the area of the nanostructured surface of the luminescence structure, and are in particular immobilized on the nanostructured surface and/or dispersed in a matrix material placed on the nanostructured surface. Nanocavities in the nanostructured surface are particularly preferred.

A carrier substrate and/or a diffractive optical carrier element is preferably used as carrier structure. It is possible that in particular the diffractive optical carrier element is produced in the frame of the method, for example by lithographic structuring or hot embossing, in particular a plastic with a high diffractive index. In a most particularly preferred way, micro-lenses are generated on the diffractive optical carrier element, in particular via hot embossing.

A simple glass or quartz substrate can be provided by way of carrier substrate.

Particular preference is given in the frame of the method to the luminescence structure with at least two different zones, wherein the different zones can be different in relation to the nanostructured surface and/or with respect to the reactive luminescence centers.

Lastly, the aim is also achieved by providing the use of a sensor element according to one of the previously described claims. Alternatively, or additionally, use of a photoluminescence detection means according to one of the previously described exemplary embodiments is provided. In the frame of the use, the sensor element is preferably used as gene chip and/or the sensor is used for the ELFA (Enzyme Linked Fluorescence Assay) method. Alternatively, or additionally, the sensor element is used as FRED (Förster Resonance Energy Transfer) sensor. Alternatively, or additionally, the sensor element is preferably used for measuring weak fluorophores, in particular for measuring intrinsic fluorescence of target substances, preferably without use of fluorescence markers.

One use of the sensor element as gene chip enables a high throughput use through parallel evaluation, in particular for the characterization of marked genetic changes. In this connection, the size of such a gene chip can be considerably reduced by means of the sensor element proposed here. Due to the very high amplification, less analysis material is required.

In the case of the ELFA method, it is a fluorescent modification of the ELISA (Enzyme Linked Immonosorbent Assay) method. In the case of the sensor element proposed here, the size of the analysis units and of the probe volumes is considerably reduced. The assembly of the apparatus is made easier.

One use of the sensor element as FRET sensor is very well suited for quantitative analyses. This use is advantageous mainly for smaller molecules such as for example ions or amino-acids. FRET sensors are very specific. The are also used for analyzing interactions between molecules. Such sensors are also called molecular rulers. Due to the fluorescence substantially intensified by the proposed sensor element, the scope of such measurements is increased.

When using the sensor element in relation to the measurement of weak fluorophores, the latter can be analyzed—preferably without increase of the incident radiation—without becoming damaged, destroyed or prematurely bleached. In particular, intrinsic fluorophores are mostly weak in their emission. Thanks to the intensification of the emission in the sensor element proposed here, weak fluorophores can also be measured and/or used as markers, for example in the frame of the ELFA method. The advantages of the intrinsic fluorescence, such as for example the possibility of making statements on modifications in the structure of an examined substance, can also be used.

By means of the sensor element proposed here, it is in particular possible to increase the sensitivity of photoluminescence measurements, to reduce the apparatus installations necessary for this, to decrease the analysis time and to achieve flexibility and open possibilities for new applications.

The description of the sensor element and of the photoluminescence detection means, which together can also be called devices, on the one hand, and of the method for operating a photoluminescence detection means as well as for producing a sensor element, together also called method, as well as the use of the sensor element and/or of the photoluminescence detection means, together called use, are to be understood as being complementary to one another. Characteristics of the devices that are described explicitly or implicitly in relation to the methods and/or the uses are characteristics preferably alone or combined with one another of preferred embodiments of the devices. Method steps or aspects of the uses that are described explicitly or implicitly in relation to the devices are steps or aspects preferably alone or combined with one another of preferred embodiments of the methods or of the uses. The latter is/are preferably characterized by at least one step or aspect determined by at least one characteristic of an inventive or preferred embodiment of a device. The devices are preferably characterized by at least one characteristic determined by at least one step or aspect of an inventive or preferred embodiment of the methods or of the uses.

### BRIEF DESCRIPTION OF THE DRAWINGS

The invention will be described hereinafter in more detail on the basis of the drawings, which show:

FIG. 1 a schematic representation of a first embodiment of a photoluminescence detection means;

FIG. 2 a schematic representation of a second embodiment of a photoluminescence detection means;

FIG. 3 a schematic detailed representation of an embodiment of a sensor element;

FIG. 4 a schematic representation of the mode of operation of an embodiment of a sensor element.

### DESCRIPTION OF EXAMPLE EMBODIMENTS

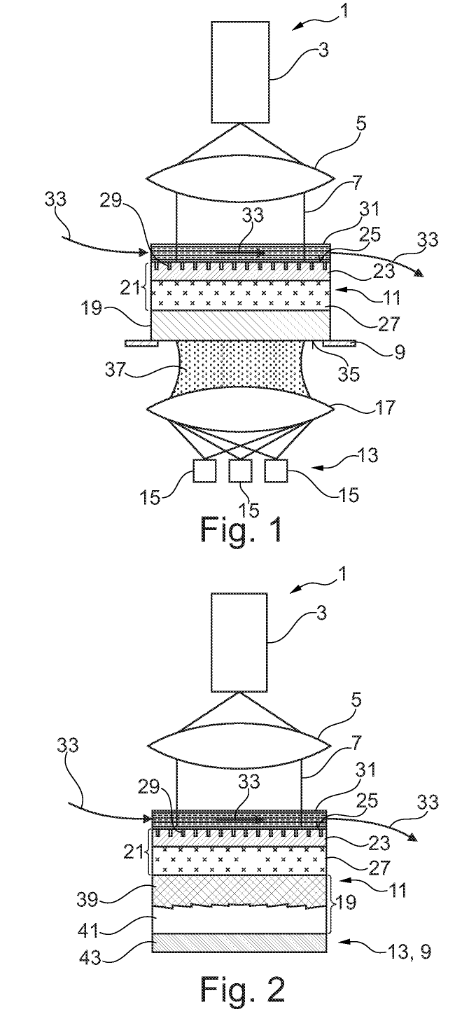

FIG. 1 shows a schematic representation of a first exemplary embodiment of a photoluminescence detection means 1 having a radiation source 3 that is configured for emitting electromagnetic radiation. The radiation source 3 is preferably executed as wideband light source for the emission of electromagnetic radiation in the visible spectrum. An illumination optical means 5, in particular a collimating optics, is associated with the radiation source 3, wherein the radiation source 3 and the illumination optical means 5 define together a beam path 7 for the electromagnetic radiation provided for the excitation of luminescence and emitted by the radiation source 3. It is possible for the illumination optical means 5 to be made integral to the radiation source 3. Alternatively, or additionally, it is possible that the illumination optical means 5 is provided at least partly or completely separate from the radiation source 3.

A holding means 9 is provided that is configured for holding a sensor element 11 in a detachable fashion in the beam path 7. In this connection, it is possible for the holding means 9 to be configured for fastening the sensor element 11. Alternatively, it is possible that the holding means 9 is configured merely for supporting, especially for carrying the sensor element 11. It is possible for the holding means 9 to have at least one stop, preferably two stops in particular oriented perpendicularly to one another, for the sensor element 11 for placing the latter in a defined position within a plane perpendicular to a direction of transmission of the sensor element 11 which in FIG. 1 runs vertically.

The photoluminescence detection means 1 furthermore has a detector device 13 that is configured for the detection of electromagnetic radiation. The detector device 13 can have a camera, a plurality of detector units arranged in an offset manner to one another, and/or a planar detector. In the exemplary embodiment represented here, the detector device has a plurality of detector units 15 arranged in an offset manner to one another.

A detection optic means 17 is associated with the detector device 13. It is possible for it to be integrated in the detector device 13 or be provided as part of the detector device 13.

Alternatively, or additionally, it is possible for the detection optical means 17 to be provided at least partly or completely separately from the detector device 13. The detection optical means 17 is configured to project luminescence radiation from the sensor element 11 onto the detector device 13.

The illumination optical means 5 and/or the detection optical means 17 can be executed as lens optics, as mirror optics and/or in another suitable manner.

The sensor element 11 is configured for photoluminescence measurements and has an optically transparent carrier structure 19. In the case of the embodiment represented here, the carrier structure 19 is executed as carrier substrate which—with the exception of transparent, translucent properties—specifically has no diffractive properties. The carrier structure 19 can be a conventional substrate, for example of glass, in particular quartz glass.

A layer thickness of the carrier structure 19 is preferably 1mm in particular in the case of glass as material for the carrier structure.

A luminescence structure 21 is placed on the carrier structure 19 and configured for the intensification and transmission of luminescence light to the carrier structure 19.

Overall, the sensor element 11 in the exemplary embodiment represented here has a layer structure, wherein the carrier structure 19 forms a first sensor layer and wherein the luminescence structure here has at least a second sensor layer, in the represented exemplary embodiment concretely two sensor layers, namely two luminescence layers. The layer structure of the sensor element 11 can preferably be, in particular is, produced lithographically and/or through an embossing process.

The luminescence structure 21 has a first, in FIG. 1 top luminescence layer 23, which has a nanostructured surface 25. Furthermore, the luminescence structure 21 has a second luminescence layer 27 that is arranged on the carrier structure 19. In this connection, the second luminescence layer 27 is placed in particular between the first luminescence layer 23 and the carrier structure 19.

A layer thickness of the first luminescence layer 23 is preferably from at least 100 nm up to at most 500 nm, wherein the thickness depends in particular on a depth of nanocavities of the nanostructured surface 25. A layer thickness of the second luminescence layer 27 is preferably from at least 30 nm up to at most 50 nm.

Alternatively, it is possible for the luminescence structure 21 to be executed as continuous, preferably homogeneous luminescence layer that has the nanostructured surface 25.

At least the first luminescence layer 23 is formed preferably of metal, at least in the region of the nanostructured surface 25. Alternatively, it is however also possible for the first luminescence layer 23 to have another material that is suitable for detecting plasmonic excitations. Generally, it is possible to use for the luminescence structure 21, in particular for the first luminescence layer 23 and most particularly in the region of the nanostructured surface 25, every material that is suitable for plasmonic excitations. Most preferably, at least the first luminescence layer 23 has silver, gold, copper or aluminum or consists of one of the said materials.

Alternatively, or additionally, the second luminescence layer 27 also has a material that is suitable for plasmonic excitations and/or for transmitting evanescent electromagnetic waves, in particular a metal. Silver, gold, copper or aluminum are preferred as materials also for the second luminescence layer 27. In particular, it is possible for the first luminescence layer 23 and the second luminescence layer 27 to have the same material. An intermediary layer is preferably provided between the two luminescence layers 23, 27 in particular when the first luminescence layer 23 and the second luminescence layer 27 have different materials.

If the luminescence structure 21 merely has one continuous layer, it preferably has the same continuous, in particular homogeneous, material, most preferably a material suitable for plasmonic excitations and for the conveying of evanescent waves, in particular a metal, most particularly silver, gold, copper or aluminum, or consists of one of said materials.

A layer thickness of the luminescence structure executed as a continuous luminescence layer 21 is preferably from at least 100 nm up to at most 600 nm, preferably up to at most 550 nm, preferably up to at most 500 nm.

The nanostructured surface 25 here has nanocavities, of which for the sake of clarity only one nanocavity here has been indicated with the reference sign 29. The nanostructure of the nanostructured surface, in particular the dimensions and/or the number density of the nanocavities 29, is/are preferably adapted to a specific wavelength range of the radiation to be amplified and/or transmitted to the carrier structure 19. The sensor element 11 is thus preferably adapted specifically to certain photoluminescence measurements, in particular to certain excitation and/or luminescence wavelengths. The nanocavities 29 are preferably arranged periodically or near-periodically along the nanostructured surface 25.

Reactive luminescence centers are preferably arranged in the region of the nanostructured surface 25 and preferably immobilized on the nanostructured surface 25 and/or dispersed in a matrix material arranged on the nanostructured surface. Most preferably, the reactive luminescence centers are placed in the nanocavities 29, namely either immobilized there and/or dispersed in a matrix provided there.

On the luminescence structure 21, a fluid conducting structure 31 is arranged that is configured for conducting a fluid over the nanostructured surface, which is here indicated schematically by means of arrows 33. The fluid conducting structure is preferably executed as a fluid conducting layer integrally formed with the layer structure of the sensor element 11 or as part of the layer structure of the sensor element 11 and is preferably produced lithographically. The fluid conducting structure 31 is preferably made of a plastic. It is preferably optically transparent, in particular thus transparent for the excitation radiation of the radiation source 3. It is possible for the fluid conducting structure 31 to have connectors (not represented) for the fluid to be conducted, in particular an inlet and a discharge.

It is possible for the luminescence structure 21 to have at least two different areas, in particular as seen along the nanostructured surface 25, wherein the areas can differ in relation to the nanostructure of the nanostructured surface 25 and/or with respect to the reactive luminescence centers arranged there. It is then possible to detect different substances to be analyzed and/or to perform different photoluminescence measurements simultaneously with one sensor element 11.

The mode of operation of the photoluminescence detection means 1 is generally as follows: by means of the fluid conducting structure 21, a fluid, in particular a solution, containing the target substances to be analyzed is conducted. The latter preferably arrive in the nanocavities 29 or to other, preferably plasmonically active structure elements of the nanostructured surface 25, where they are preferably bound—chemically or physically—by reactive luminescence centers. Luminescence, preferably fluorescence, is induced in the substances and/or in the reactive luminescence centers thanks to the radiation emitted by the radiation source 3, wherein the excitation radiation is intensified by means of the nanostructure of the nanostructured surface, in particular in the nanocavities 29. Most preferably, standing waves of the excitation radiation, which undergo a strong amplification, are then formed in the nanocavities 29. Luminescence radiation coupled into the luminescence structure through the periodical arrangement of the nanocavities 29 in the form of evanescent waves, amplified and transmitted through the luminescence structure to the carrier structure 19. The excitation radiation of the radiation source 3, in contrast thereto, is attenuated through the non-transparent luminescence structure 21—in particular depending on the layer thickness of the luminescence structure 21—wherein in particular attenuations of up to a factor of 10⁻⁵ are readily achievable. The evanescent waves are preferably amplified by the second luminescence layer 27, wherein simultaneously the wideband excitation light of the radiation source 3 is attenuated. At the transition of the luminescence structure 21 to the carrier structure 19, the evanescent waves thus amplified are uncoupled as propagating light modes, for which preferably the carrier structure 19 has a material with a high refractive index.

Between the carrier structure 19, in particular between a surface 35 of the carrier structure 19 oriented towards the detection optical means 17 and the detection optical means 17, an immersion medium is placed that preferably also has highly refractive properties. The immersion medium 37 can be water or an immersion oil. The material of the carrier structure 19 and/or of the immersion medium 37 are preferably chosen so that the luminescence radiation of different wavelengths is deflected in different directions, without being subjected to the effect of total reflection, so that the different wavelengths of different detector units 15 can be observed. It is thus possible to perform separately different luminescence measurements at the same time. In particular, it is also possible to direct luminescence radiation from different places on the nanostructured surface to different detector units 15, so that different substances can be analyzed and/or different photoluminescence measurements can be readily performed simultaneously at different locations of the nanostructured surface 25.

The sensor element 11 is preferably executed as a single-use element, in particular as a disposable element. It can be produced cost-effectively and replaced easily. In this respect, it has in particular both a materials analyzer system and a filter system for luminescence light, so that these specific parts from the exchangeable sensor element 11 are provided for specific luminescence measurements and/or analytic tasks. The photoluminescence detection means 1 can, on the other hand, be extremely flexibly suitable for a plurality of different substances to be analyzed and/or photoluminescence measurements, wherein it is configured for specific tests by placing on the holding means 9 a sensor element 11 specifically provided for this. It is thus possible to switch very easily in a cost-effective and quick manner between different test tasks, by simply exchanging the sensor element 11. At the same time, the nanostructured surface 25 causes a very narrowband highly efficient intensification or amplification of the excitation light in the nanocavities 29, wherein simultaneously the luminescence structure 23 provides an outstanding attenuation of the light of the radiation source 3 in the direction of the detector. Luminescence light and excitation light can thus be cleanly separated from one another, so that a wideband radiation source 3 can be used. Therefore, the photoluminescence detection means 1 require no specific configuring—with the exception of the sensor element 11—rather, the entire specific functionality is shifted onto the sensor 11, which can be exchanged in a cost-effective and quick manner. The photoluminescence detection means 1 is therefore overall extremely flexible.

In the frame of a method for operating the photoluminescence detection means, a first sensor element 11 in particular is placed between the radiation source 3 and the detector device 13. A first photoluminescence measurement is performed. The first sensor element 11 is removed and a second sensor element 11 is placed between the radiation source 3 and the detector device 13 and a second photoluminescence measurement is performed. In this respect, the first and the second sensor element preferably differ, wherein preferably alternatively or additionally the second photoluminescence measurement and the first photoluminescence measurement also differ. In the frame of the method, the photoluminescence detection means is thus used very flexibly and at the same time cost-effectively.

FIG. 2 shows a schematic representation of a second embodiment of the photoluminescence detection means 1. Elements that are the same and fulfil the same function are provided with the same reference signs, so that in this respect reference is made to the preceding description.

In the second exemplary embodiment represented here, the carrier structure 19 is executed as a diffractive optical carrier element, i.e. it has itself specifically provided optically refractive properties. In the embodiment represented here concretely, the carrier structure 19 has a first diffractive layer 39 and a second optically merely transparent non-diffractive carrier layer 41.

The diffractive layer 39 and the carrier layer 41 are preferably produced integrally with one another as a layer structure, in particular lithographically. It is however also possible that the diffractive layer 39 in particular is given its optically diffractive properties through hot embossing or through lithographic structuring. Hot embossing in particular will enable micro-lenses to be placed or formed in the diffractive layer 39. The diffractive layer 39 preferably consists of plastic with a low diffractive index.

In this respect, the material for the carrier structure 19 is preferably chosen such that luminescence radiation of different frequency is deflected in various directions, without being subjected to the effect of total reflection.

A layer thickness of a diffractive layer 39 is preferably from at least 5 mm to at most 10 mm. The carrier layer 41 preferably has a greater, in particular a much greater, thickness.

The detector device 13 here has a planar detector 43, which most preferably is executed as CCD sensor or CMOS sensor. The detector device 13 in this connection is not associated with any detection optical means of its own, rather, the carrier layer 19 and in particular the diffractive layer 39 serve as detection optical means. The planar detector 43 respectively the detector device 13 are here executed as holding means 9, wherein the sensor element 11 with the carrier structure 19 and in particular with the carrier layer 41 is preferably simply placed on the planar detector 43. It is then possible to detect luminescence radiation of different wavelengths in different areas of the planar detector 43 that can be analyzed separately from one another. The planar detector 43 preferably has pixels that can be evaluated separately. Pixel binning enables the sensitive surface of the detector 43 to be customized—preferably under software control—for every application case during operation. Pixel binning is understood to be a grouping of pixels during evaluation and/or reading of the planar detector 43, wherein preferably the charge accumulated by the grouped pixels is added up. In this manner, the light sensitivity and thus the detection strength of the planar detector 43 are increased, although this is at the cost of the resolution.

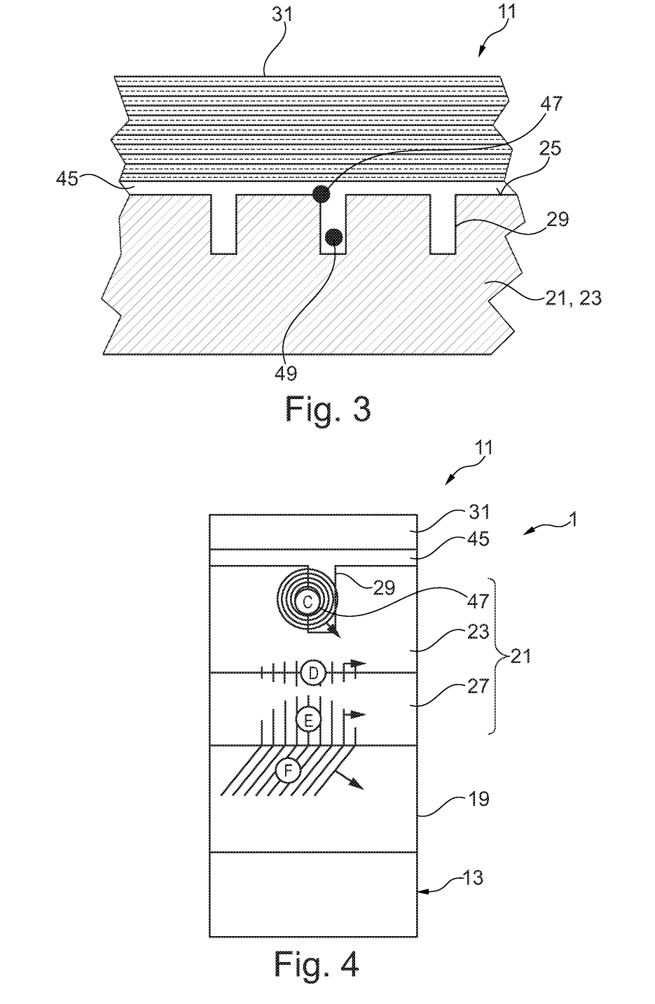

FIG. 3 shows a schematic detailed representation of a further exemplary embodiment of a sensor element 11. Elements that are the same and fulfil the same function are provided with the same reference signs, so that in this respect reference is made to the preceding description. In the exemplary embodiment represented here, a matrix material 45 is arranged between the fluid conducting structure 31 and the nanostructured surface 25 respectively also in the nanostructured surface 25, and which can preferably have a polymer or gel or consists of a polymer or gel. The matrix material 45 is in particular configured to allow a diffusion of substances to be analyzed from the fluid flowing in the fluid conducting structure 31 to reactive luminescence centers 47, 49. Thanks to the appropriate choice of matrix composition, i.e. the composition and/or design of the matrix material 45, in particular special pore sizes or the use of polar matrix molecules, the ion selectivity of the matrix material 45 can also be adjusted.

A first, schematically outlined, reactive luminescence center 47 is immobilized, preferably bound, here on the nanostructured surface 25, wherein a second reactive luminescence center 49, represented here schematically, is dispersed in the matrix material 45.

FIG. 4 shows a schematic representation of the basic mode of operation of the sensor element 11. Elements that are the same and fulfil the same function are provided with the same reference signs, so that in this respect reference is made to the preceding description. In this respect, C represents a first reactive luminescence center 47 placed in immobilized fashion in a nanocavity 29 and which emits luminescence radiation. This is in particular the case when a substance to be analyzed is bound, preferably chemically or physically, at the reactive luminescence center 47. The luminescence radiation emitted by the reactive luminescence center 47 and/or by the substance bound thereto as wave with evanescent components is bound in the luminescence structure 21 and in particular in the first luminescence layer 23, excites surface plasmons there and, by means of a resonance interaction of the existing charge carriers of the material boundary surfaces, is transmitted to the second luminescence layer 27 and amplified. This is represented on the one hand at D and on the other hand at E. The second luminescence layer 27, with its amplification mechanism, in this respect acts preferably as a Pendry lens.

F represents the decoupling as propagating light modes of the amplified evanescent waves in the transition zone between the second luminescence layer 27 and the carrier structure 19, wherein they are transmitted from the carrier structure 19 to the detector device 13. In this respect, luminescence radiation of different wavelengths is deflected in different directions.

Due to the fact that standing waves are formed in the nanocavities 29 and that the periodicity of the nanocavities also excites surface plasmons that have strong evanescent field components, field amplifications can thus be achieved of approximately a factor 10. This amplification can be adjusted through the specific design of the geometry of the nanocavities 29 to different wavelengths and can in particular have peak widths at half-height of approximately 20 nm.

The evanescent amplification in particular in the second luminescence layer 27 can be adjusted to an amplification factor of up to 200. The attenuation of the excitation light is primarily determined by the thickness of the luminescence structure 21, in particular of the second luminescence layer 27, and can overall reach a factor 10⁻⁵ for the layer thicknesses appropriate for the sensor element 21.

The sensor element 11 is preferably produced by providing the carrier structure 19, wherein a luminescence structure 21 is placed on the carrier structure 19, wherein the luminescence structure 21 is produced with a nanostructured surface, and wherein preferably a fluid conducting structure 31 is placed on the luminescence structure 21. The sensor element 11 and/or the photoluminescence detection means 1 are preferably used for a gene chip measurement, wherein in particular the sensor element 11 is used as a gene chip, for the use of the ELFA method, for FRET measurements, wherein the sensor element is used as FRED sensor, or for the measurement of weak fluorophores, in particular for the measurement of the intrinsic fluorescence of target substances, preferably without using fluorescence markers.

Overall, it has been shown that by means of the sensor element 11, a flexible biosensor can be provided that is excitable by a wideband radiation source. Individual excitation wavelengths are consequently of reduced intensity and must be amplified. This amplification mechanism amplifies here neither the wideband excitation light nor the scattered light, but, thanks to the clever use of the nanostructured surface 25 and of the luminescence structure 21, exclusively the excitation wavelength provided specifically for the excitation of the luminescence. The resulting luminescence light is also amplified, but simultaneously the amplified narrowband excitation light, the non-amplified wideband excitation light and the scattered light are effectively attenuated. This is achieved in particular through the combination of a plasmonic filter with the evanescent amplification of a Pendry lens layer. Thus, in the frame of the devices proposed here, a combination of elements of plasmonics, Pendry lenses and geometric optics together is used to be able to perform highly flexible and at the same time extremely efficient photoluminescence measurements.

1. Sensor element (11) for photoluminescence measurements, with
an optically transparent carrier structure (19), on which is placed
a luminescence structure (21) configured for intensifying and transmitting luminescence light to the carrier structure (19), wherein
the luminescence structure has a nanostructured surface (25) oriented away from the carrier structure (19).

2. Sensor element (11) according to claim 1, characterized in that the sensor element (11) has a layer structure, wherein the carrier structure (19) has at least a first sensor layer and the luminescence structure (21) has at least a second sensor layer, wherein the layer structure can preferably be produced lithographically and/or through an embossing process.

3. Sensor element (11) according to claim 1, characterized in that reactive luminescence centers (47, 49) are arranged in the area of the nanostructured surface of the luminescence structure (21), which preferably
a) are immobilized on the nanostructured surface (25), and/or
b) are dispersed in a matrix material (45) placed on the nanostructured surface (25).

4. Sensor element (11) according to claim 1, characterized in that the nanostructured surface (25) has nanocavities (29), wherein reactive luminescence centers (47, 49) are preferably arranged in the nanocavities (29).

5. Sensor element (11) according to claim 1, characterized in that a fluid conducting structure (31) is arranged on the luminescence structure (21) and is configured for conducting a fluid over the nanostructured surface (25).

6. Sensor element (11) according to claim 1, characterized in that the luminescence structure (21)
a) has a first luminescence layer (23) that has the nanostructured surface (25), wherein the luminescence structure (21) has a second luminescence layer (27) arranged on the carrier structure (19), or
b) is formed as a continuous, preferably homogeneous luminescence layer that has the nanostructured surface (25).

7. Sensor element (11) according to claim 1, characterized in that the carrier structure (19) is executed
a) as carrier substrate, and/or
b) as diffractive optical carrier element.

8. Sensor element (11) according to claim 1, characterized in that the luminescence structure (21) has at least two different areas, wherein the wherein the areas differ in relation to the nanostructured surface (25) and/or with respect to the reactive luminescence centers (47,49).

9. Photoluminescence detection means (1) according to claim 1, with
a radiation source (3), configured for emitting electromagnetic radiation;
a holder (9), configured for detachably holding a sensor element (11) in a beam path (7) of the radiation source (3), and
a detector device (13), configured for the detection of electromagnetic radiation, wherein
the holder (9) is configured for holding said sensor element (11) in the beam path (7) of the radiation source (3) between the radiation source (3) and the detector device (13).

10. Photoluminescence detection means (1) according to claim 9, characterized in that the photoluminescence detection means (1) comprises the sensor element (11).

11. Photoluminescence detection means (1) according to claim 9, characterized in that the detector device (13) has
a) a camera,
b) a plurality of detector units (15) arranged in an offset manner to one another, and/or
c) a planar detector (43).

12. Method for operating the photoluminescence detection means (1) according to claim 9, with the following steps:
placing a first sensor element (11) between the radiation source (3) and the detector device (13);
performing a first photoluminescence measurement;
removing the first sensor element (11) and placing a second sensor element (11) between the radiation source (3) and the detector device (13), and
performing a second photoluminescence measurement.

13. Method according to claim 12, characterized in that the second sensor element (11) is different from the first sensor element (11) and/or in that the second photoluminescence measurement is different from the first photoluminescence measurement.

14. Method for producing a sensor element (11) according to claim 1, with the following steps:
providing a carrier structure (19);
placing a luminescence structure (21) on the carrier structure (19), wherein the luminescence structure (21) is produced with a nanostructured surface (25), and preferably
placing a fluid conducting structure (31) on the luminescence structure (21).

15. Use of a sensor element (11) according to claim 1:
as gene chip;
for the ELFA method;
as FRET sensor, and/or
for measuring weak fluorophores including for measuring the intrinsic fluorescence of target substances, without using fluorescence markers.
